(19) United States
(12) Patent Application Publication
(10) Pub. No.: US 2021/0287561 A1
(43) Pub. Date: Sep. 16, 2021

(54) LECTURE SUPPORT SYSTEM, JUDGEMENT APPARATUS, LECTURE SUPPORT METHOD, AND PROGRAM

(71) Applicant: NEC Corporation, Minato-ku, Tokyo (JP)

(72) Inventors: Daiki UDAKA, Tokyo (JP); Hisashi IWAMURA, Tokyo (JP)

(73) Assignee: NEC Corporation, Minato-ku, Tokyo (JP)

(21) Appl. No.: 17/275,479

(22) PCT Filed: Sep. 13, 2019
(86) PCT No.: PCT/JP2019/036153

§ 371 Date: Mar. 11, 2021

(30) Foreign Application Priority Data
Sep. 14, 2018 (JP) 2018-172528

(51) Int. Cl. G09B 5/04; G06Q 50/20

(52) U.S. Cl. CPC G09B 5/04; G06Q 50/20

(57) ABSTRACT

A lecture support system is configured to comprise: a monitor apparatus that monitors speech and behavior of a teacher during a lecture and extracts trigger information among his speeches and behaviors during the lecture; an image analysis apparatus that obtains a first shot image of a student during lecture and estimates a visual direction of the student based on the first shot image; and a judgment apparatus that judges the degree of concentration of the student based on the visual direction and a preferred visual direction according to the trigger information extracted by the monitor apparatus.

### REFERENCE TO RELATED APPLICATION

This application is a National Stage Entry of PCT/JP2019/036153 filed on Sep. 13, 2019, which claims priority from Japanese Patent Application 2018-172528 filed on Sep. 14, 2018, the contents of all of which are incorporated herein by reference, in their entirety. The present invention relates to a lecture support system, judgement apparatus, lecture support method, and program.

### TECHNICAL FIELD

### Background

When a teacher gives a lecture to multiple students in a classroom, it is difficult for the teacher to perform lecture while giving support for each student's learning attitude. As a result, it is difficult for the teacher to know which student is concentrating on the lecture and which is not when he is teaching multiple students in the classroom.

Patent Literature 1 (PTL 1) describes a technology that detects whether or not a user's visual direction is directed to a display of a television receiver, judges whether the user is in a normal viewing state, a “while doing” state, or a “concentration” state, and controls playback characteristics of at least one of video and audio according to the judged state.

Patent Literature 2 describes a technology that recognizes a face of a student based on the student image, which is the moving image of the student's face shot during a lecture, performs analysis on the recognized face, and outputs information on the analysis results.

Patent Literature 3 describes a technology to support communication between a speaker and a listener. The technology described in Patent Literature 3 generates a content that is a candidate to be spoken by the speaker, and detects that the speaker has used the generated content. The technology described in Patent Literature 3 analyzes a response of the listener at a timing before and after detection of the speaker's use of the generated content, and registers the result of the analysis as profile information of the listener. Furthermore, in the technology described in Patent Literature 3, the content that is a candidate to be spoken by the speaker is updated based on the profile information.

Patent Literature 4 describes an educational support system comprising a plurality of terminal devices and a server. The terminal device described in Patent Literature 4 comprises an audio output part that output audio data of digital content, a playback log data storage part that stores playback log data for each phrase, and a transmission part that transmits the playback log data. The server described in Patent Literature 4 also comprises a digital content storage part in which digital content to be distributed to each terminal device is stored. The server described in Patent Literature 4 also comprises a data conversion part that receives playback log data from each terminal device and converts the received playback log data into playback time and playback count for each phrase. Furthermore, the server described in Patent Literature 4 comprises a server display part that displays the converted data. Furthermore, the server described in Patent Literature 4 comprises a display control part that indicates the time required to play a phrase string in terms of horizontal length, and also displays the number of times played for each phrase on the same screen.

### [PTL 1]

Japanese Patent Kokai Publication No. JP2004-312401A

### [PTL 2]

Japanese Patent Kokai Publication No. JP2013-061906A

### [PTL 3]

Japanese Patent Kokai Publication No. JP2016-177483A

### [PTL 4]

Japanese Patent Kokai Publication No. JP2016-212169A

### SUMMARY

The disclosure of the above NPL 1 to 4 are incorporated herein by reference thereto. The following analysis has been made according to the view of the present invention.

As mentioned above, when a teacher gives a lecture to multiple students in a classroom, it is difficult for the teacher to know which student(s) is/are concentrating on learning and which is/are not.

Furthermore, the lecture situation changes as the lecture progresses, such as a phase of the teacher explaining, a phase of the students doing an exercise, and so on.

For example, if a student is looking toward a direction of a teacher in a situation where the teacher is explaining, it can be assumed that the student is concentrating on the lecture (i.e., teacher's explanation). On the other hand, if the student is looking toward a direction other than the teacher's direction (e.g., downward) while the teacher is explaining, it can be assumed that the student is not concentrating on the lecture.

However, if the student is doing an exercise and is looking toward a direction where a teacher is, it can be assumed that the student is not concentrating on the lecture (i.e., exercise). On the other hand, if the student is looking down while doing the exercise, it can be assumed that the student is concentrating on the lecture.

The technology described in Patent Literature 1 detects a visual direction of a user and judges whether the user is concentrating on an object or not. But as mentioned above, a visual direction of a student taking a lecture changes as the lecture progresses. Therefore, if status of the lecture is unknown, the technology described in Patent Literature 1 cannot be used to determine whether the student is concentrating or not.

In the technology described in Patent Literature 2, a student's face during a lecture is shot and analysis is performed on the student's face. However, as mentioned above, relationship between a direction of the student's face and the student's degree of concentration differs depending on the lecture situation. Therefore, if the lecture situation is unknown, the technology described in Patent Literature 2 cannot be used to determine whether the student is concentrating or not.

It is a main purpose of the present invention to provide a lecture support system, judgement apparatus, lecture support method, and program that contributes to easily grasp degree of concentration of a student, even when lecture situation changes.

According to a first aspect of the present invention or disclosure, there is provided a lecture support system, comprising: a monitor apparatus that monitors speech and behavior of a teacher during a lecture, and extracts trigger information from the speech and behavior; an image analysis apparatus that captures a first shot image of a student during the lecture, and estimates a visual direction of the student based on the first shot image; and a judgement apparatus that judges degree of concentration of the student based on the visual direction and a preferred visual direction according to the trigger information extracted by the monitor apparatus.

According to a second aspect of the present invention or disclosure, there is provided a judgement apparatus that obtains trigger information that represents specified speech and behavior of a teacher during a lecture, obtains information that represents a visual direction of a student, and judges degree of concentration of the student based on a preferred visual direction according to the trigger information and the visual direction.

According to a third aspect of the present invention or disclosure, there is provided a method of supporting lecture, comprising: obtaining trigger information that represents specified speech and behavior of a teacher among his speeches and behaviors during a lecture; obtaining information that represents a visual direction of a student; and judging degree of concentration of the student based on a preferred visual direction according to the trigger information and the visual direction.

According to a fourth aspect of the present invention or disclosure, there is provided a program that causes a computer to perform processing of: obtaining trigger information that represents specified speech and behavior of a teacher among his speeches and behaviors during a lecture; obtaining information that represents a visual direction of a student; and judging degree of concentration of the student based on a preferred visual direction according to the trigger information and the visual direction.

The above-mentioned program can be recorded in a computer-readable storage medium. The storage medium may be a non-transient medium such as a semiconductor memory, a hard disk, a magnetic recording medium, or an optical recording medium. The present invention can be implemented as a computer program product.

According to an individual aspect of the present invention, there are provided a lecture support system, judgement apparatus, lecture support method, and program that contributes to easily grasp degree of concentration of a student, even when the lecture situation changes.

### BRIEF DESCRIPTION OF THE DRAWINGS

FIG. 1 is a diagram illustrating an outline of one example embodiment.

FIG. 2 is a diagram illustrating an example of an overall configuration of a lecture support system 100 according to first to third example embodiments.

FIG. 3 is a diagram illustrating an example of an internal configuration of a voice monitor apparatus 10.

FIG. 4 is a diagram illustrating an example of reference trigger information.

FIG. 5 is a diagram illustrating an example of an internal configuration of a first shoot apparatus 20.

FIG. 6 is a diagram illustrating an example of an internal configuration of an image analysis apparatus 30.

FIGS. 7A and 7B are a diagram illustrating an example of a correspondence of identification information of a student to a position of the student, respectively.

FIG. 8 is a diagram illustrating an example of estimated result of visual direction.

FIG. 9 is a block diagram illustrating an example of an internal configuration of a judgement apparatus 40.

FIG. 10 is a diagram illustrating an example of a table that associates reference trigger information with reference visual direction.

FIG. 11 is a diagram illustrating an example of a table showing an example of judged result of degree of concentration of a student.

FIG. 12 is a diagram illustrating an example of an internal configuration of a display apparatus 50.

FIG. 13 is a diagram illustrating an example of information showing a position of a student.

FIG. 14 is a diagram illustrating an example of a display screen.

FIG. 15 is a flowchart illustrating an example of operation of a lecture support system 100 according to a first example embodiment.

FIG. 16 is a diagram illustrating an example of totalization result of degree of concentration of a student.

FIGS. 17A and 17B are a diagram illustrating an example of totalization result of degree of concentration of a student, respectively.

FIG. 18 is a flowchart illustrating an example of behavior of a lecture support system 100 according to a third example embodiment.

FIG. 19 is a diagram illustrating an example of an overall configuration of a lecture support system 100a according to a fourth example embodiment.

FIG. 20 is a diagram illustrating an example of an internal configuration of a second shoot apparatus 60.

FIG. 21 is a diagram illustrating an example of a hardware configuration of a computer 1.

### PREFERRED MODES

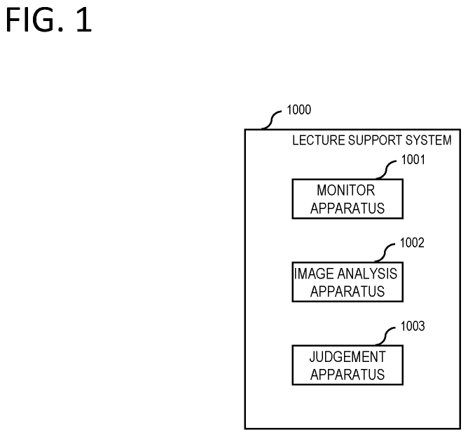

First, an outline of an example embodiment will be described using FIG. 1. In the following outline, various components are attached with reference signs for the sake of convenience. Namely, the following reference signs are merely used as examples to facilitate understanding of the outline. Thus, the disclosure of the outline is not intended to limit in any way. In addition, connecting lines between blocks in each figure include both bidirectional and unidirectional. One-way arrow schematically shows a flow of a main signal (data) and does not exclude bidirectionality. Also, in a circuit diagram, a block diagram, an internal configuration diagram, a connection diagram, etc., there are an input port and an output port at input end and output end of connection line respectively, although not explicitly disclosed. The same applies for an I/O interface.

As described above, it is desirable to have a lecture support system, a judgment apparatus, a method of lecture support, and a program that contribute to easily grasping degree of concentration of a student even when the lecture situation changes.

Therefore, as an example, a lecture support system 1000 illustrated in FIG. 1 is provided. The lecture support system 1000 is configured to comprise a monitor apparatus 1001, an image analysis apparatus 1002, and a judgment apparatus 1003.

The monitor apparatus 1001 monitors speech and behavior of a teacher during lecture, and extracts trigger information from the speech and behavior. Here, trigger information is assumed to be information that represents the teacher's words and behavior according to lecture situations.

an image analysis apparatus 1002 obtains a first shot image that shot a student during lecture, and estimates a visual direction of the student based on the first shot image;

The judgement apparatus 1003 judges degree of concentration of a student based on a visual direction and a preferred visual direction according to trigger information extracted by the monitor apparatus 1001. Here, the preferred visual direction means the direction which is desirable for student to look in, according to the situation of the lecture (or lesson) in a class. For example, in a situation where a teacher is explaining, the preferred visual direction should be directed to the teacher (e.g., forward), and in a situation where students are doing exercises, the preferred visual direction should be toward the desk (i.e., downward).

In other words, a lecture support system 1000 determines whether a visual direction of a student is a desirable direction or not, according to a lecture situation, and judges degree of concentration of the student. Therefore, the lecture support system 1000 contributes to easily grasping degree of concentration of the students even when the lecture situation changes.

### First Example Embodiment

A first example embodiment will be described in more detail with reference to the drawings.

A lecture support system 100 according to this embodiment can be used in a lecture conducted in a school classroom or the like. Furthermore, the lecture support system 100 of this example embodiment may be used in remote classes. The term “remote lecture” refers to a lecture conducted at a different location from where a student is. In a remote lecture, a lecture conducted by a teacher is captured as images (i.e., shot), and the students receive the lecture via a display.

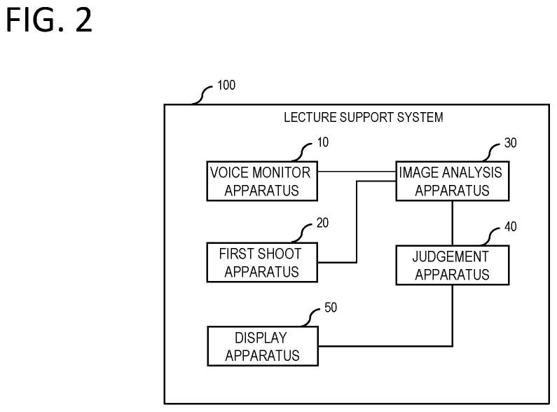

FIG. 2 is a diagram illustrating an example of an overall configuration of a lecture support system 100. The lecture support system 100 is configured to comprise an voice monitor apparatus (monitor apparatus) 10, a first shoot apparatus 20, an image analysis apparatus 30, a judgment apparatus 40, and a display apparatus 50.

The voice monitor apparatus 10 monitors (obtains) voice during the teacher's lecture and extracts trigger information from the obtained voice. The trigger information should include a specified word(s) (hereinafter may be referred to as “reference trigger information”) that is included in voice uttered by a teacher. The reference trigger information should be word(s) that the teacher could have uttered during the lecture and that represents status of the lecture. In the following description, the trigger information extracted by the audio monitor apparatus 10 is also referred to as target trigger information.

The voice monitor apparatus 10 may be configured to include a microphone. In such a case, the microphone is installed at a position where it is possible to obtain voice uttered by the teacher during a lecture. The voice monitor apparatus 10 may also be configured with a function for extracting trigger information, etc., built into the microphone.

The first shoot apparatus 20 is a camera that shoots student(s) in a lecture. More concretely, the first shoot apparatus 20 is installed in a position where it can shoot the face(s) of one or more students. The first shoot apparatus 20 shoots the face(s) of one or more students and generates a shot image (first shot image).

The image analysis apparatus 30 obtains a shot image of a student in a lecture (first shot image) and estimates a visual direction of the student based on the first shot image. The image analysis apparatus 30 may be implemented using cloud computing.

The judgment apparatus 40 obtains trigger information representing a specified word(s) or behavior(s) of a teacher during a lecture, obtains information representing a visual direction of a student, and judges degree of concentration of the student based on a preferred visual direction according to the target trigger information and the visual direction of the student. Concretely, the judgment apparatus 40 judges the degree of concentration of the student based on the preferred visual direction and the visual direction of the student according to the trigger information extracted by the voice monitor apparatus 10 (target trigger information). The judgment apparatus 40 may be implemented using cloud computing.

The display apparatus 50 comprises a display that shows the result(s) of the judgment of degree of concentration of a student(s). It is preferable that the display apparatus 50 is installed in a position where a teacher can check it during lecture. By monitoring the degree of concentration of the student displayed on the display apparatus 50, the teacher can give necessary instructions to the student whose degree of concentration is decreasing. For example, the display apparatus 50 may be implemented using a tablet terminal or the like.

### [Configuration of Voice Monitor Apparatus]

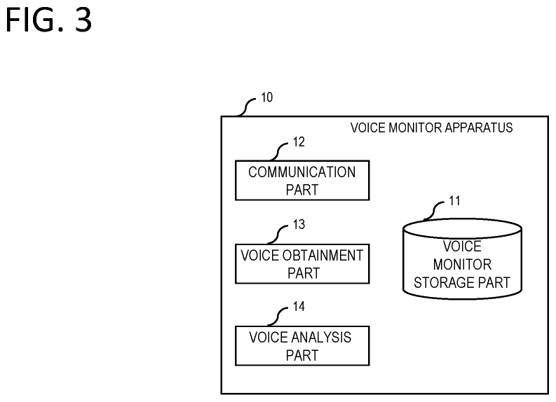

Next, A configuration of the voice monitor apparatus 10 will be explained in detail. FIG. 3 is a diagram of an example of an internal configuration of the voice monitor apparatus 10. The voice monitor apparatus 10 comprises a voice monitor storage part 11, a communication part 12, a voice obtainment part 13, and a voice analysis part 14.

The voice monitor storage part 11 stores a plurality (two or more) of specified words (reference trigger information). For example, the voice monitor storage part 11 is implemented by a magnetic disk apparatus, optical disk apparatus, semiconductor memory, etc.

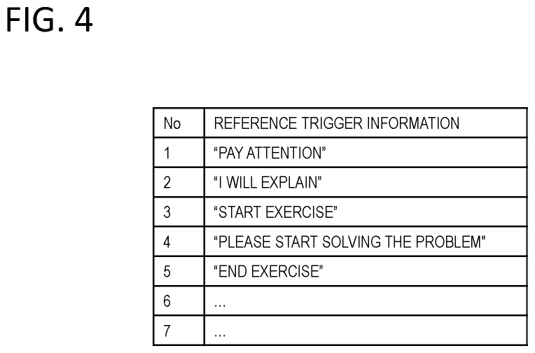

FIG. 4 is a diagram illustrating an example of reference trigger information. For example, as shown in FIG. 4, the voice monitor storage part 11 stores words such as “pay attention,” “I will explain,” “start exercise,” “please start solving the problem,” “end exercise,” etc. as reference trigger information.

For example, The voice monitor storage part 11 may store different reference trigger information for each teacher. By doing so, the voice monitor apparatus 10 can appropriately extract trigger information from voice uttered by a teacher, even when each teacher conducts a lecture in his or her own unique way. As a result, the voice monitor apparatus 10 can appropriately extract trigger information from the voice uttered by the teacher, while allowing the teacher to proceed with the lecture in his/her own way.

The communication part 12 communicates with the first shoot apparatus 20 via a network. Here, the network may be a wireless LAN (Local Area Network), the Internet, etc., and the details of the communication method are not required. In the same way, the details of the communication type of the network are not required.

The voice monitoring apparatus 10 may accept words corresponding to reference trigger information from an external source. For example, the communication part 12 may receive character information of a plurality (two or more) of words as reference trigger information. When the voice monitor apparatus 10 receives the character information of the plurality of words, the received character information may be registered in the voice monitor storage part 11 as the reference trigger information.

For example, the communication part 12 may receive audio signals corresponding to a plurality of words as reference trigger information. When the voice monitor apparatus 10 receives an audio signal corresponding to a plurality of words, it converts the received audio signal into text (character information), respectively. The speech monitoring signal may then register the text (character information) generated based on a speech signal in a voice monitor storage part 11 as reference trigger information.

The voice obtainment part 13 obtains a voice uttered by a teacher. The voice obtainment part 13 is implemented using a microphone.

The speech analysis part 14 extracts word(s) corresponding to specified word(s) (reference trigger information) stored by the voice monitor storage part 11 from a voice acquired by the voice obtainment part 13 as trigger information. As mentioned above, the trigger information extracted by the speech analysis part 14 is also referred to as the target trigger information.

Concretely, the voice analysis part 14 judges whether or not the voice uttered by a teacher (i.e., the voice obtained by the voice obtainment part 13) contains word(s) corresponding to the reference trigger information. If the voice uttered by the teacher (i.e., the voice obtained by the voice obtainment part 13) includes the word(s) corresponding to the reference trigger information, the word(s) is/are extracted as trigger information (target trigger information). Then, the voice analysis part 14 transmits the extracted trigger information (target trigger information) to the first shoot apparatus 20 via the communication part 12.

For example, the voice monitor storage part 11, the communication part 12, and the voice analysis part 14 may be configured as an integrated part of a microphone.

### [Configuration of Shoot Apparatus]

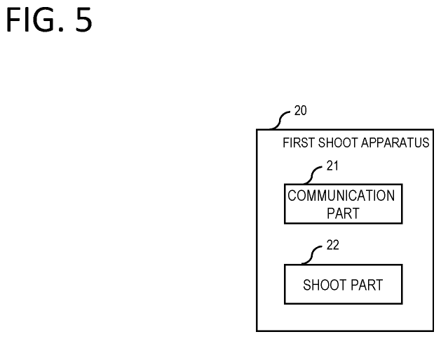

Next, a configuration of the first shoot apparatus 20 will be described in detail. FIG. 5 is a diagram illustrating an example of the internal configuration of the first shoot apparatus 20. The first shoot apparatus 20 comprises a communication part 21 and a shoot part 22.

The communication part 21 communicates with the voice monitor apparatus 10 and the image analysis apparatus 30 via a network. The communication part 21 receives target trigger information from the voice monitor apparatus 10.

The shoot part 22 is a camera that captures image(s) of a student in a lecture. The shoot part 22 shoots the face(s) of one or more students and generates a shot image (first shot image). The shoot part 22 then transmits the shot image(s) (first shot image) and target trigger information received by the communication part 21 to the image analysis apparatus 30 via the communication part 21.

### [Configuration of Image Analysis Apparatus]

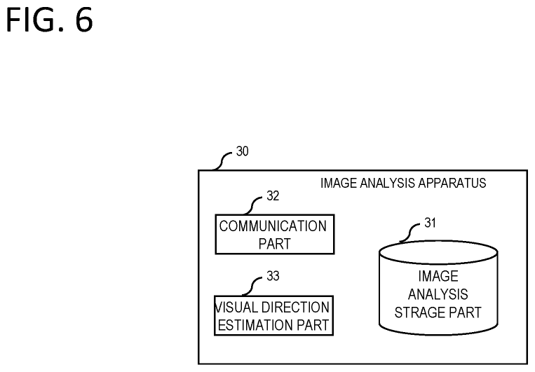

Next, the configuration of the image analysis apparatus 30 will be described in detail. FIG. 6 is a diagram illustrating an example of internal configuration of the image analysis apparatus 30. The image analysis apparatus 30 comprises an image analysis storage part 31, a communication part 32, and a visual direction estimation part 33.

The image analysis storage part 31 stores in advance information corresponding to information that identifies a student (hereinafter also referred to as student identification information) and a position of the student in the captured image. The image analysis storage part 31 is realized by a magnetic disk apparatus, optical disk apparatus, semiconductor memory, etc.

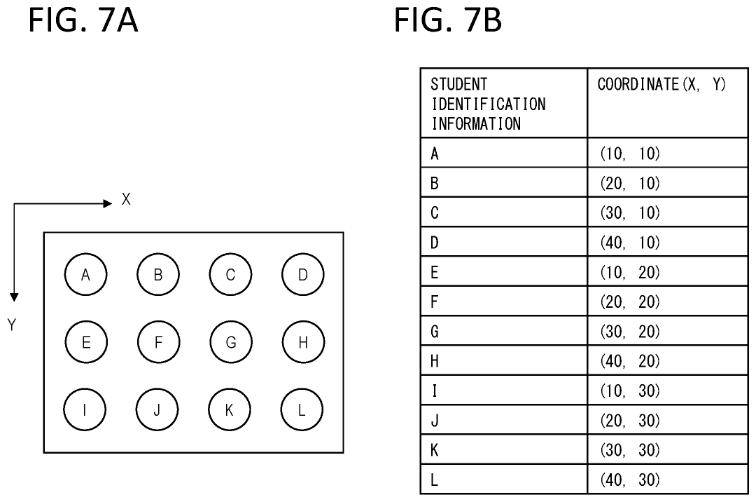

FIGS. 7A and 7B are a diagram illustrating an example of the correspondence between student identification information and the position of a student in a shot image, respectively. FIG. 7A is a diagram illustrating the positions of students in the first shot image. The circles in FIG. 7A represent students (students A-L) in the first shot image. FIG. 7B is a table that associates the student identification information with the position of the student in the shot image (coordinates in the shot image). For example, FIG. 7B represents that a person detected within a specified range centered at coordinate (X, Y)=(10, 10) in the first shot image is student A.

The communication part 32 communicates with the first shoot apparatus 20 and the judgment apparatus 40 via a network.

The visual estimation part 33 obtains a first shot image of a student in a lecture and estimates a visual direction of the student based on the first shot image. Concretely, the visual estimation part 33 obtains the first shot image from the first shoot apparatus 20 via the communication part 32. Then, the visual estimation part 33 estimates the visual direction of the student based on the first shot image. The method for estimating the visual direction may use any known method.

For example, the visual estimation part 33 detects a person from the first shot image. The visual estimation part 33 identifies the position of the outer corner(s) of the eye(s), the position of the inner corner(s) of the eye(s), and the position of the black eye area of the detected person. Then, the visual estimation part 33 may estimate the visual direction of a student based on the position of the black eye area relative to the detected position of the outer corner of the eye and the position of the inner corner of the eye. Here, the visual estimation part 33 estimates the visual direction for each student when two or more faces of the students are detected in the first shot image.

Furthermore, the visual estimation part 33 may judge that the visual direction of a person is downward if an area of the detected face area of the person is at or less than a specified threshold value for the entire area of the person. Alternatively, if the captured image does not include an eye area of the detected person, but includes an area corresponding to the upper head, the visual estimation part 33 may judge that the visual direction of the person is downward.

For example, suppose that the image analysis storage part 31 stores information shown in FIG. 7B in advance. Then, suppose that the visual estimation part 33 detects a person within a specified range centered on coordinate (X, Y)=(10, 10) in the first shot image. In that case, the visual estimation part 33 refers to information stored by the image analysis storage part 31 and identifies the person as student A.

Then, the visual estimation part 33 transmits a result of the estimation of the visual direction of a student and received target trigger information to the judgment apparatus 40 via the communication part 32. Concretely, the visual estimation part 33 transmits information corresponding to the student identification information and the estimation result of visual direction of each student, as well as the received target trigger information, to the judgment apparatus 40 via the communication part 32.

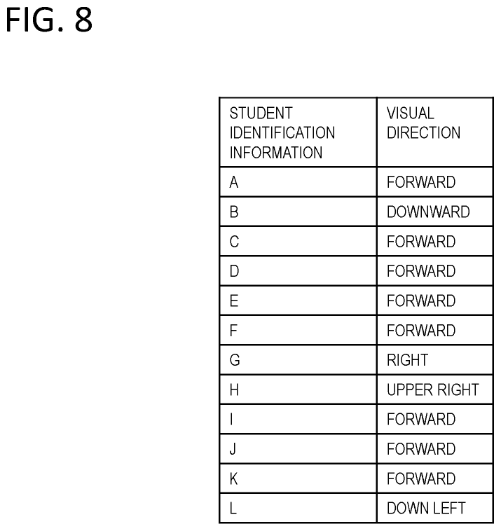

FIG. 8 is a diagram illustrating an example of the estimation result of the visual direction. FIG. 8 is information that associates the identification information of the student with the estimated result of the visual direction for students A to L.

### [Configuration of Judgement Apparatus]

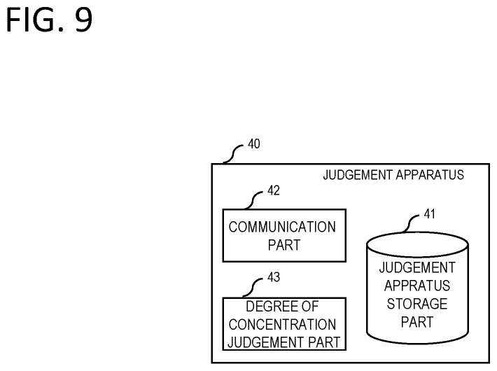

Next, a configuration of the judgment apparatus 40 will be explained in detail. FIG. 9 is a diagram illustrating an example of an internal configuration of the judgment apparatus 40. The judging apparatus 40 comprises a judgment apparatus storage part 41, a communication part 42, and a degree of concentration judgment part 43.

The judgment apparatus storage part 41 stores reference information that associates the reference trigger information with the reference visual direction in advance. The reference trigger information is configured to include a plurality (two or more) of specified words. In addition, the reference visual direction represents an appropriate visual direction for a student in a lecture situation, corresponding to the reference trigger information. For example, the judgment apparatus storage part 41 is implemented by a magnetic disk apparatus, optical disk apparatus, semiconductor memory, etc.

Here, reference trigger information included in reference information is assumed to be the same as the reference trigger information stored by the voice monitor storage part 11. The judgment apparatus storage part 41 may store different reference trigger information for each teacher in the same way as the voice monitor storage part 11.

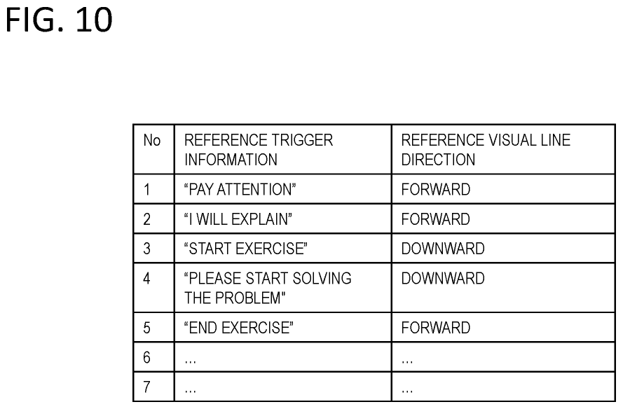

FIG. 10 is a diagram illustrating an example of reference information. FIG. 10 illustrates a table that associates reference trigger information with the reference visual direction as reference information. Concretely, the reference information illustrated in FIG. 10 includes the words “pay attention,” “I will explain,” “start exercise,” “please start solving the problem,” and “end exercise” as the reference trigger information. Furthermore, the reference information shown in FIG. 10 includes information indicating proper visual direction, corresponding to each reference trigger information, as a reference visual direction. For example, the reference information illustrated in FIG. 10 includes a combination of the reference trigger information “attention” and the reference visual direction “forward”. For example, the reference information shown in FIG. 10 includes a combination of the reference trigger information “start exercise” and the reference visual direction “downward”.

The communication part 42 communicates with the voice monitor apparatus 10, the image analysis apparatus 30, and the display apparatus 50 via a network. The communication part 42 receives, from the image analysis apparatus 30, an estimation result of the visual direction of a student and target trigger information. The communication part 42 also transmits a result of the determination of the degree of concentration of the student to the display apparatus 50.

The judgment apparatus 40 may accept reference information from an external source. For example, the communication part 42 may receive a combination of reference trigger information and reference visual direction. When the judgment apparatus 40 receives the combination of the reference trigger information and the reference visual direction, it may register (add) the received combination to the judgment apparatus storage part 41 as reference information.

A teacher who uses the lecture support system 100 may, in advance, register a combination of an expression corresponding to the teacher (reference trigger information) and a reference visual direction in a judgment apparatus 40 before the lecture starts. For example, the teacher may use a terminal device (PC (Personal Computer)) (not illustrated) used by him/her to input a combination of an expression corresponding to the teacher (reference trigger information) and a reference visual direction. In that case, the terminal apparatus transmits the combination of the input reference trigger information and the reference visual direction to the judgment apparatus 40. The judgment apparatus 40 may then register (add) the combination of the reference trigger information and the reference visual direction transmitted from the terminal apparatus to the judgment apparatus storage part 41 as reference information.

Alternatively, when the judgment apparatus 40 is equipped with an input device (keyboard, mouse, touch panel, etc.) (not illustrated), a combination of a reference trigger information and a reference visual direction may be received via the input device. A teacher using the lecture support system 100 may, before starting the lecture, input a combination of an expression corresponding to the teacher (reference trigger information) and a reference visual direction in advance, using the input device. In that case, the judgment apparatus 40 may register (add) the combination of the input reference trigger information and the reference visual direction to the judgment apparatus storage part 41 as reference information.

The degree of concentration judgment part 43 judges a degree of concentration of a student based on the preferred visual direction according to the trigger information extracted by the voice monitor device 10 (target trigger information) and a visual direction of the student estimated by the image analysis apparatus 30.

Concretely, The degree of concentration judgment part 43 refers to the reference information and specifies a reference visual direction corresponding to a received trigger information (target trigger information) as a preferred visual direction. If the direction of visual of a student is the preferred visual direction, the degree of concentration judgment part 43 judges that the student is concentrating. On the other hand, if the visual direction of the student is not the preferred visual direction, the degree of concentration judgment part 43 judges that the student is not concentrating. Then, the degree of concentration judgment part 43 transmits a result of the judgment of the degree of concentration of the student to the display apparatus 50 via the communication part 42.

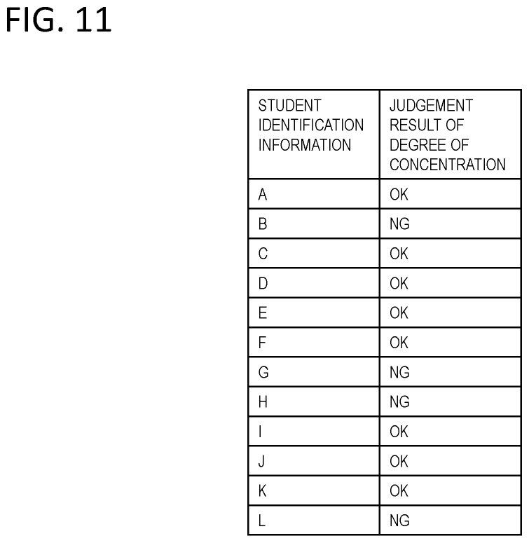

For example, suppose that the judgment apparatus storage part 41 stores a reference information illustrated in FIG. 10. Also suppose that the communication part 42 receives information representing “pay attention” as trigger information (target trigger information) extracted by the voice monitor apparatus 10. Here, in reference information shown in FIG. 10, a reference visual direction corresponding to the reference trigger information “pay attention” is “forward”. Therefore, the degree of concentration judgment part 43 identifies “forward” as a preferred visual direction. Furthermore, suppose that the communication part 42 receives information shown in FIG. 8 as a result of estimated visual direction of a student. In that case, the degree of concentration judgment part 43 judges the degree of concentration of the student as illustrated in FIG. 11. In FIG. 11, “OK” represents result of judgment that a student is concentrating, while “NG” in FIG. 11 represents result of judgment that a student is not concentrating.

### [Configuration of Display Apparatus]

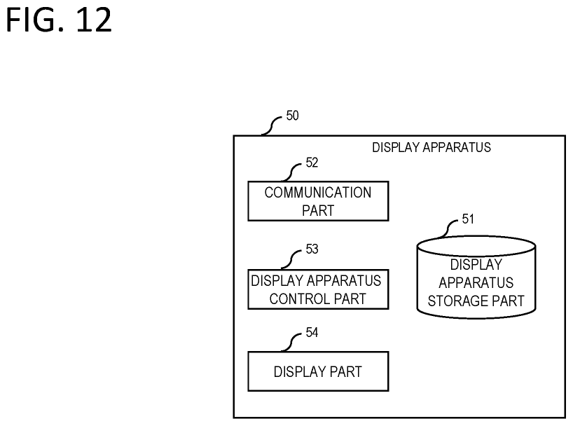

Next, A configuration of the display apparatus 50 will be described in detail. FIG. 12 is a diagram illustrating an example of an internal configuration of a display apparatus 50. The display apparatus 50 comprises a display apparatus storage part 51, a communication part 52, a display apparatus control part 53, and a display part 54.

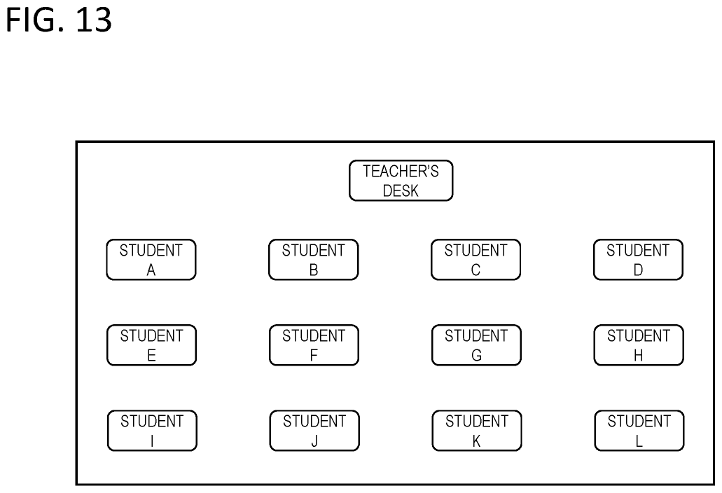

The display device storage part 51 stores information representing a position of a student in advance, as illustrated in FIG. 13. The display device storage part 51 is realized by a magnetic disk apparatus, optical disk apparatus, semiconductor memory, etc.

The communication part 52 communicates with a judgment apparatus 40 [sic. display apparatus 50] via a network. The communication part 52 receives results of judgment of a degree of concentration of a student from a display apparatus 50 [sic. judgement apparatus 40].

The display device control part 53 generates information to be displayed on the display part 54 (display screen), and executes a process to display the generated information on the display part 54. Concretely, the display device control part 53 generates a display screen based on the judgment result of degree of concentration of the student received by the communication part 52. Then, the display device control part 53 executes the process of displaying the generated display screen on the display part 54.

The display part 54 displays information based on instructions of the display apparatus control part 53. Concretely, the display part 54 displays the display screen generated by the display apparatus control part 53 based on the instructions of the display apparatus control part 53. For example, the display part 54 is realized using an LCD (Liquid Crystal Display), an OLED (Electro-Luminescence) display, or the like.

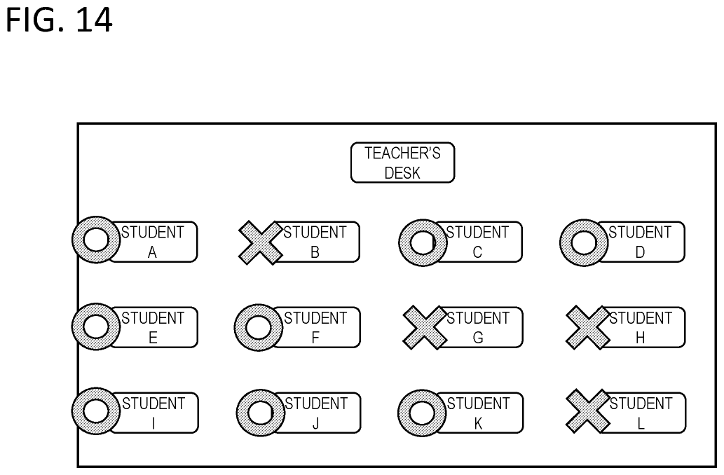

FIG. 14 is a diagram of an example of a display screen, as displayed by the display part 54. FIG. 14 shows positions of students A to L and results of judgment of a degree of concentration of the students. In FIG. 14, a “◯” marked to the right [sic. left] of a student's name indicates the result of the judgment that the student is concentrating. On the other hand, an “X” marked to the right [sic. left] of the student's name in FIG. 14 indicates that the student is not concentrating. A teacher can easily check whether each student is concentrating or not by looking at the display screen shown in FIG. 14 during a lecture.

### [Operation of Lecture Support System]

Next, operation of the lecture support system 100 according to this example embodiment will be described in detail.

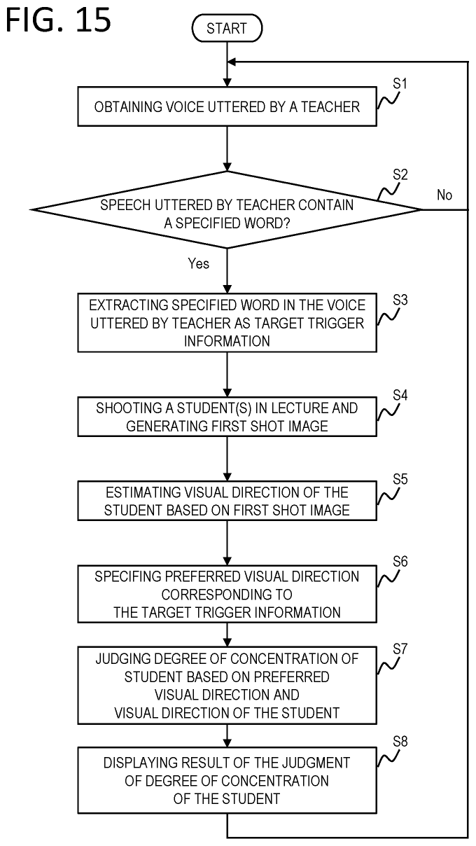

FIG. 15 is a flowchart illustrating an example of operation of the lecture support system 100.

In step S1, the voice monitor apparatus 10 obtains a voice uttered by a teacher.

In step S2, the first shoot apparatus 20 judges whether or not the voice uttered by the teacher contains a specified word(s). If the voice uttered by the teacher does not contain the specified word(s) (No branch of step S2), the system returns to step S1 and continues the process.

On the other hand, if the voice uttered by the teacher includes the specified word (Yes branch of step S2), the voice monitor apparatus 10 extracts the specified word included in the voice uttered by the teacher as target trigger information (step S3). Then, the voice monitor apparatus 10 transmits the target trigger information to first shoot apparatus 20.

In step S4, the first shoot apparatus 20 shoots a student participating in a lecture and generates a first shot image. The first shoot apparatus 20 transmits the first shot image and the received target trigger information to the image analysis apparatus 30. Here, the first shoot apparatus 20 may shoot a student participating in the lecture and generate the first shot image after a specified time (e.g., 2 to 3 seconds) has elapsed after receiving the target trigger information from the voice monitor apparatus 10. This is because it takes a specified amount of time (e.g., 2-3 seconds) for a student to receive an instruction from the teacher and to act in response to the instruction.

In step S5, then image analysis apparatus 30 estimates the visual direction of the student based on the first shot image. The image analysis apparatus 30 transmits the estimated result of the visual direction of the student and the received target trigger information to the judgment apparatus 40.

In step S6, the judgment apparatus 40 specifies a preferred visual direction corresponding to the target trigger information.

In step S7, the judgment apparatus 40 judges degree of concentration of the student based on the preferred visual direction and the visual direction of the student. The judgment apparatus 40 transmits the result of the judgment of the degree of concentration of the student to the display apparatus 50.

In step S8, the display apparatus 50 displays the result of the judgment of the degree of concentration of the student. The lecture support system 100 repeats the process from step S1 to step S8 from the start of the lecture to the end of the lecture.

As described above, in the present example embodiment of the lecture support system 100, the voice monitor apparatus 10 monitors the voice uttered by the teacher during the lecture, and judges whether or not the voice contains the specified word(s). Then, in the lecture support system 100 according to the present example embodiment, the image analysis apparatus 30 determines the preferred visual direction of the student according to the specified word(s) included in the voice uttered by the teacher during the lecture. Then, in the lecture support system 100 according to the present example embodiment, the judgment apparatus 40 judges whether or not the student is in the preferred visual direction, and judges the degree of concentration of the student. Then, in the lecture support system 100 of the present example embodiment, the display apparatus 50 displays to the teacher whether the student is concentrating on the lecture or not. Therefore, by using the lecture support system 100 according to the present example embodiment, the teacher can conduct the lecture while knowing whether the student(s) is/are concentrating or not, even when the lecture situation (during explanation, during exercises, etc.) changes. Therefore, the lecture support system 100 of this example embodiment contributes for the teacher to easily and continuously grasp the degree of concentration of the student(s) while conducting the lecture in his or her own way.

### Second Example Embodiment

This example embodiment is a configuration that totalizes degree of concentration of students. In the explanation of this example embodiment, the explanation of the part that overlaps with the above example embodiment is omitted. Furthermore, in the explanation of this example embodiment, the same sign is attached to the same components as in the above example embodiment, and the explanation thereof is omitted. In addition, in the explanation of this example embodiment, the explanation of the same action and effect as the above example embodiment is also omitted. The same applies to the other configurations below.

An overall configuration of the lecture support system 100 for this example embodiment is shown in FIG. 2. The internal configuration of the voice monitor apparatus 10, the first shoot apparatus 20, the image analysis apparatus 30, the judgment apparatus 40, and the display apparatus 50 for this embodiment is shown in FIGS. 3, 5, 6, 9, and 12, respectively. In the following description, the differences from other example embodiments will be explained in detail.

A degree of concentration judgment part 43 for this example embodiment judges degrees of concentration of two or more students and summed up the degrees of concentration of the students. Then, the degree of concentration judgment part 43 in this example embodiment transmits the summed up results of the degree of concentration of the students to the display apparatus 50 via the communication part 42.

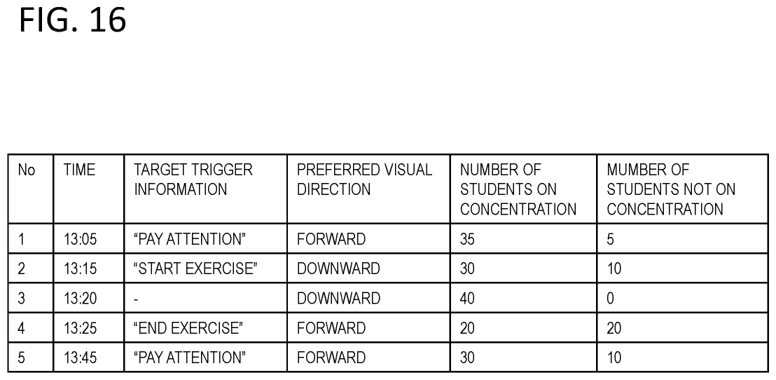

FIG. 16 is a diagram illustrating an example of a total result of concentration of students. FIG. 16 illustrates a table that shows time, target trigger information, preferred visual direction, number of students who are concentrating, and number of students who are not concentrating in association with each other. For example, the second row of FIG. 16 shows that the target trigger information with “pay attention” was extracted at time “13:05” (13:05). Furthermore, the second row of FIG. 16 shows that the preferred visual direction corresponding to the target trigger information “pay attention” is forward. In addition, the second row of FIG. 16 shows that the number of students judged by the judgment apparatus 40 to be concentrated at time “13:05” is 35. Furthermore, the second row of FIG. 16 shows that the number of students that the judgment apparatus 40 judged to be not concentrated at time “13:05” is 5.

The display apparatus control part 53 of this example embodiment generates a display screen based on the total results of the degree of concentration of students received by the communication part 52. Then, the display apparatus control part 53 performs a process of displaying the generated display screen on the display part 54.

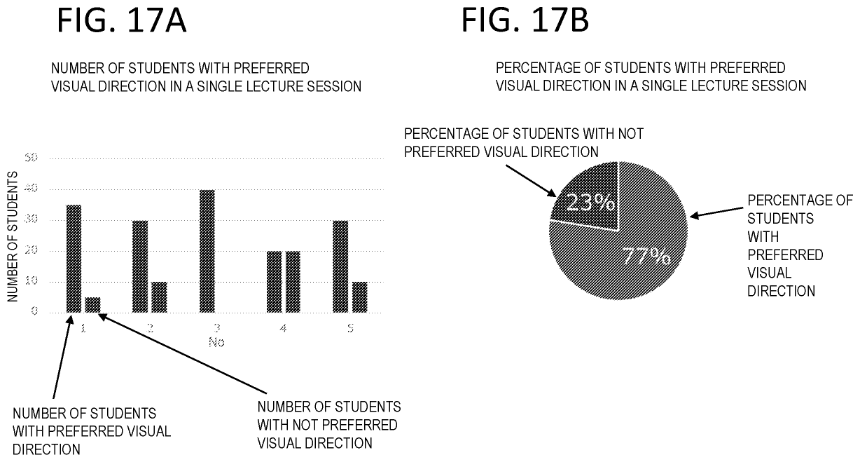

FIGS. 17A and 17B are diagrams illustrating an example of the total result of degree of concentration of students. FIG. 17A is diagram of the total result of degree of concentration of the students illustrated in FIG. 16, using a bar graph. FIG. 17B is a diagram of the totaled results of degree of concentration of the students shown in FIG. 16 using a pie chart. For example, by displaying the bar graph shown in FIG. 17A, the pie chart shown in FIG. 17B, etc., the display apparatus 50 allows the teacher, et al. to easily grasp the degree of concentration of the students for one entire lecture.

As described above, the lecture support system 100 of this example embodiment totalizes the degrees of concentration of the students in the entire lecture and displays the total results of the degree of concentration of the students to the teachers and others. As a result, the lecture support system 100 of the present example embodiment contributes to the teacher's efforts to improve the way of how to conduct the lecture after the lecture by reviewing the total results of the degree of concentration of the students. In addition, the lecture support system 100 contributes to making it easier for a management team to evaluate the teacher by presenting the total results of the degree of concentration of the students to the management team.

### Third Example Embodiment

This example embodiment is a configuration that re-judges the degree of concentration of a student based on latest target trigger information when no words that are target trigger information are detected from voice of a teacher in a lecture for a specified period of time.

An overall configuration of the lecture support system 100 for this example embodiment is illustrated in FIG. 2. The internal configuration of the voice monitor apparatus 10, the first shoot apparatus 20, the image analysis apparatus 30, the judgment apparatus 40, and the display apparatus 50 for this example embodiment is illustrated in FIG. 3, FIG. 5, FIG. 6, FIG. 9, and FIG. 12, respectively. In the following description, the differences from other example embodiments will be explained in detail.

If the voice monitor apparatus 10 does not extract any new trigger information within a specified time after extracting a specified word(s) from the voice as the target trigger information, the visual direction estimation part 33 in this example embodiment re-estimates the visual direction of the student. Then, the degree of concentration judgment part 43 of this example embodiment re-judges the degree of concentration of the student based on the latest extracted target trigger information and the re-estimated visual direction of the student.

Then, if the newly judged degree of concentration of the students (e.g., the number of students concentrating, etc.) is less than a specified threshold, the degree of concentration judgment part 43 sends alert information to the display apparatus 50. Alternatively, if the newly determined number of students who are concentrating is decreasing beyond a specified threshold compared to the latest determined number of students who are concentrating, the degree of concentration judgment part 43 may send alert information to the display apparatus 50. When the display apparatus 50 receives the alert information from the judgment apparatus 40, it displays the received alert information.

For example, the alert information may be information that instructs the teacher to give a call to the students in accordance with the lecture situation (e.g., “pay attention”, “start exercise”, etc.).

### [Operation of Lecture Support System]

Next, operation of the lecture support system 100 of this example embodiment will be described in detail.

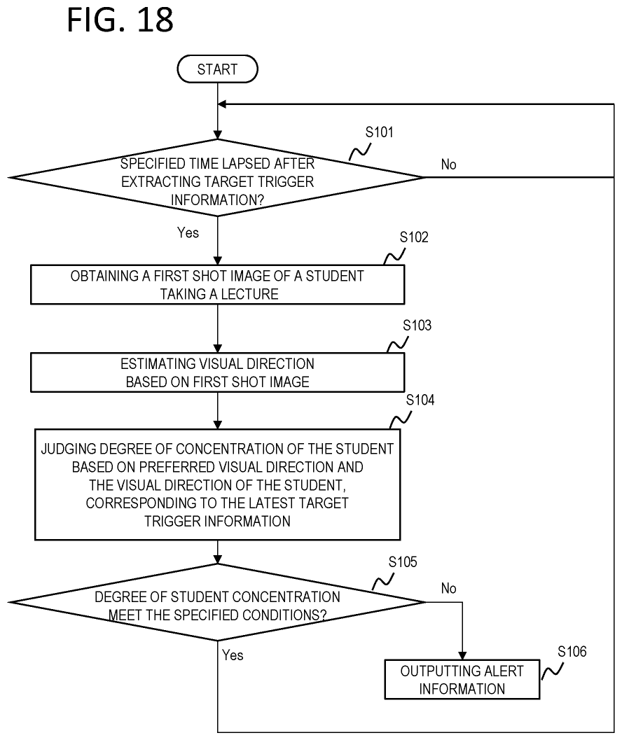

FIG. 18 is a flowchart illustrating an example of the operation of the lecture support system 100.

In step S101, the voice monitor apparatus 10 judges whether or not a specified time has elapsed after the voice monitor apparatus 10 extracted the target trigger information. If the specified time has not elapsed since the voice monitor apparatus 10 extracted the target trigger information (No branch of step S101), it returns to step S101 and continues the process. When the voice monitor apparatus 10 extracts new target trigger information, the process from step S4 illustrated in FIG. 15 is executed.

On the other hand, when the specified time has elapsed after the voice monitor apparatus 10 extracts the target trigger information (Yes branch of step S101), the first shoot apparatus 20 obtains a first shot image of a student taking a lecture (step S102).

In step S103, the image analysis apparatus 30 estimates a visual direction of the student based on the first shot image.

In step S104, the judgment apparatus 40 judges degree of concentration of the student based on the preferred visual direction and the visual direction of the student, corresponding to the latest target trigger information.

In step S105, the judgment apparatus 40 judges whether or not the degree of concentration of the student(s) satisfies the specified condition. For example, if the number of student(s) concentrating, etc. is at or below a specified threshold, the judgment apparatus 40 may judge that the specified condition is not satisfied. On the other hand, if the number of concentrated students, etc. exceeds the specified threshold, the judgment apparatus 40 may judge that the specified condition is satisfied.

Alternatively, if the number of students who are concentrating has decreased beyond a specified threshold compared to the latest determined number of students who are concentrating, the judgment apparatus 40 may judge that the specified condition is not met. If the number of concentrated students has not decreased beyond a specified threshold compared to the latest judged number of concentrated students, the judgment apparatus 40 may judge that the specified condition is satisfied.

If the degree of concentration of the student(s) satisfies the specified condition (Yes branch of step S105), the process returns to step S101 and continues. On the other hand, if the degree of concentration of the student(s) does not meet the specified condition (No branch of step S105), the display apparatus 50 outputs the alert information (step S106). Concretely, the judgment apparatus 40 transmits the alert information to the display apparatus 50. When the display apparatus 50 receives the alert information from the judgment apparatus 40, it displays the received alert information.

As described above, in the present example embodiment of the lecture support system 100, the judgment apparatus 40 re-judges the degree of concentration of the students based on the latest target trigger information when no words that are the target trigger information are detected for a specified period of time from the voice of the teacher in the lecture. Then, in the present example embodiment of the lecture support system 100, when the degree of concentration of the students does not meet the specified condition, the display apparatus 50 displays information instructing the teacher to give a call to the students in accordance with the lecture situation. Therefore, the lecture support system 100 of this example embodiment contributes to preventing a reduction in the degree of concentration of the students by encouraging the teacher to give a call to the students according to the situation of the lecture.

### Fourth Example Embodiment

This example embodiment is a configuration that grasps the status of the lecture based on a shot image of status of a teacher.

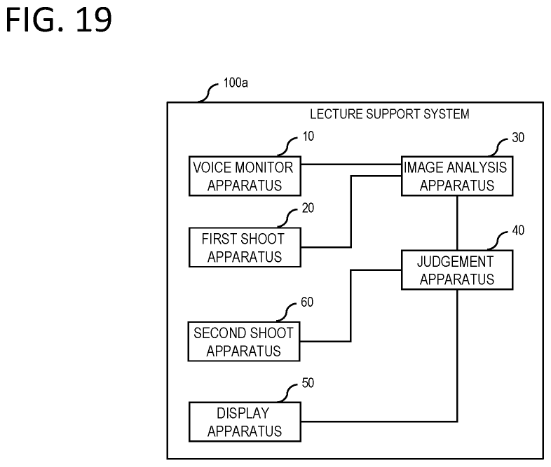

FIG. 19 is a diagram illustrating an example of an overall configuration of a lecture support system 100a. The difference between the lecture support system 100a illustrated in FIG. 19 and the lecture support system 100 illustrated in FIG. 2 resides in that the lecture support system 100a illustrated in FIG. 19 is configured to comprise a second shoot apparatus (monitoring apparatus) 60. The internal configurations of the voice monitor apparatus 10, the first shoot apparatus 20, the image analysis apparatus 30, the judgment apparatus 40, and the display apparatus 50 for the present example embodiment are as illustrated in FIG. 3, FIG. 5, FIG. 6, FIG. 9, and FIG. 12, respectively.

The second shoot apparatus 60 obtains a second shot image of a teacher during a lecture, and judges the state of the teacher based on the second shot image. If the state of the teacher is a specified state (e.g., explaining, watching (a student(s)) doing an exercise, etc.), the second shoot apparatus 60 specifies information indicating the specified state as the target trigger information.

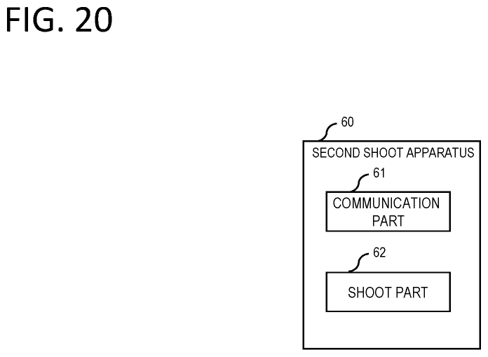

FIG. 20 is a diagram illustrating an example of an internal configuration of the second shoot apparatus 60 of the present example embodiment. The second shoot apparatus 60 comprises a communication part 61 and a shoot part (image capturing part) 62.

The communication part 61 communicates with the judgment apparatus 40 via a network.

The shoot part 62 is a camera that takes image(s) of a teacher during a lecture. The camera captures images of the teacher during the lecture and generates a shot image (a second shot image).

The image analysis apparatus 30 judges the state of the teacher based on the second shot image. If the state of the teacher is a specified state (e.g., explaining, watching exercising, etc.), the image analysis apparatus 30 obtains the information indicating the specified state as the target trigger information. Then, the image analysis apparatus 30 sends the shot image (the second shot image) to the judgment apparatus 40 via the communication part 61.

The judgment apparatus storage part 41 for this example embodiment regards the information indicating the state of the teacher as reference trigger information, and stores reference information in advance, wherein the reference information associates the reference trigger information with the reference visual direction. The reference trigger information for this example embodiment includes information indicating a plurality (two or more) of specified states (explaining, watching the exercise being performed, etc.).

The degree of concentration judgment part 43 of this example embodiment judges the degree of concentration of the student based on the preferred visual direction according to the target trigger information identified by the second shoot apparatus 60 and the visual direction of the student estimated by the image analysis apparatus 30.

Concretely, the degree of concentration judgment part 43 refers to the reference information and identifies the reference visual direction, which corresponds to the information representing the state of the teacher (target trigger information), as the preferred visual direction. If the visual direction of the student is in the preferred visual direction, the degree of concentration judgment part 43 judges that the student is concentrating. On the other hand, if the visual direction of the student is not in the preferred visual direction, the degree of concentration judgment part 43 judges that the student is not concentrating. Then, the degree of concentration judgment part 43 transmits the result of the judgment of the degree of concentration of the student to the display apparatus 50 via the communication part 42.

As described above, in the present example embodiment of the lecture support system 100a, the second shoot apparatus 60 shoots the state of the teacher during the lecture and judges whether the state of the teacher is in a specified state or not. Then, in the present example embodiment of the lecture support system 100a, the judgment apparatus 40 judges the preferred visual direction for the student(s) according to the state of the teacher during the lecture. Then, in the present example embodiment of the lecture support system 100a, the judgment apparatus 40 judges whether or not the student is in the preferred visual direction, and judges the degree of concentration of the student. Then, in the lecture support system 100a according to the present example embodiment, it is displayed to the teacher whether or not the student is concentrating on the lecture. Therefore, the lecture support system 100a according to the present example embodiment allows the teacher to conduct a lecture while knowing whether the student(s) is/are concentrating or not, even when the teacher give a call according to the situation of the lecture to the student(s) using an expression different from the words registered in the voice monitor apparatus 10. The lecture support system 100a of this example embodiment contributes to the teacher easily and continuously grasping the degree of concentration of the students while conducting the lecture in his or her own way even more.

Next, a computer that realizes the image analysis apparatus 30 and judgment apparatus 40 of the above example embodiment(s) will be described.

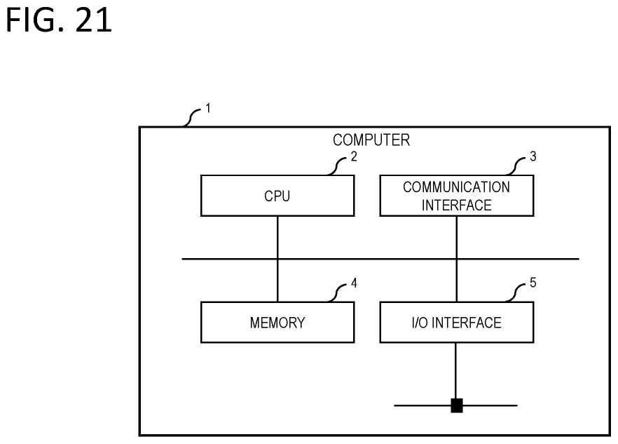

FIG. 21 is a diagram illustrating an example of a hardware configuration of the computer 1 that realizes the image analysis apparatus 30 and the judgment apparatus 40.

For example, computer 1 is equipped with a CPU (Central Processing Unit) 2, communication interface 3, memory 4, input/output interface 5, etc., which are interconnected by an internal bus. The communication interface 3 is a NIC (Network Interface Card) or the like. Memory 4 is a magnetic disk apparatus, optical disk apparatus, semiconductor memory, etc. Input/output interface 5 is an interface such as LCD, OLED display, etc., keyboard, touch panel, etc.

The functions of the image analysis apparatus 30 and the judgment apparatus 40 are realized by the CPU 2 executing a program stored in the memory 4. All or part of the functions of the image analysis apparatus 30 and the judgment apparatus 40 may be realized (implemented in hardware) by hardware such as FPGA (Field Programmable Gate Array) and ASIC (Application Specific Integrated Circuit). The above program may also be used to connect to a network. In addition, the above program can be downloaded via a network or updated using a storage medium that stores the program. Furthermore, the functions of the image analysis apparatus 30 and the judgment apparatus 40 may be realized by a semiconductor chip(s). In other words, the functions of the image analysis apparatus 30 and the judgment apparatus 40 can be realized by executing software in certain hardware.

The basic hardware configuration of the computer that realizes the voice monitor apparatus 10, the first shoot apparatus 20, the display apparatus 50, and the second shoot apparatus 60 can also be likewise as the computer 1. The voice monitor apparatus 10 is configured by comprising a microphone. The first and second shoot apparatuses 20 and 60 are configured by comprising a camera. The display apparatus 50 is configured by including a display (LCD, OLED display, etc.).

In the description of the above example embodiments, we have illustrated and described a configuration in which the voice monitor apparatus 10 transmits the target trigger information to the first shoot apparatus 20. But this does not mean that the voice monitor apparatus 10 is limited to sending the target trigger information to the first shoot apparatus 20. For example, the voice monitor apparatus 10 may transmit the target trigger information to the judgment apparatus 40.

The disclosure of the above PTL etc. is incorporated herein by reference thereto, can be used as the basis or part of the present invention if necessary. Variations and adjustments of the example embodiments and examples are possible within the scope of the disclosure (including the claims) of the present invention and based on the basic technical concept of the present invention. Various combinations and selections (including partial deletion) of various disclosed elements (including the elements in the claims, example embodiments, examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been concretely disclosed. In the present invention, when an algorithm, software, flowchart, or automated process step is presented, it is evident that a computer is used, and it is also evident that the computer is equipped with a processor and memory or storage device. Therefore, it is understood that these elements are naturally described in the present application even if they are not explicitly presented.

### REFERENCE SIGNS LIST

1 computer
2 CPU (Central Processing Unit)
3 communication interface
4 memory
5 input/output interface
10 voice monitor apparatus
11 voice monitor storage part
12,21,32,42,52,61 communication part
13 voice obtainment part
14 voice analysis part
20 first shoot apparatus
22,62 shoot part
30,1002 image analysis apparatus
31 analyzed image storage part
33 visual direction estimation part
40,1003 judgement apparatus
41 judgement apparatus storage part
43 degree of concentration judgement part
50 display apparatus
51 display apparatus storage part
53 display apparatus control part
54 display part
60 second shoot apparatus
100,100a,1000 lecture support system
1001 monitor apparatus

What is claimed is:

1-10. (canceled)

11. A lecture support system, comprising:
a monitor apparatus that monitors speech and behavior of a teacher during a lecture, and extracts trigger information from the speech and behavior;
an image analysis apparatus that captures a first shot image of a student during the lecture, and estimates a visual direction of the student based on the first shot image; and
a judgement apparatus that judges degree of concentration of the student based on the visual direction and a preferred visual direction according to the trigger information extracted by the monitor apparatus.

12. The lecture support system according to claim 11, wherein
the trigger information includes a predetermined word included in voice spoken by the teacher.

13. The lecture support system according to claim 11, wherein
the trigger information includes information regarding status of the teacher.

14. The lecture support system according to claim 11, wherein
the judgement apparatus comprises:
a storing part that stores in advance reference information that associates reference trigger information with a reference visual direction; wherein
if the trigger information extracted by the monitor apparatus corresponds to the reference trigger information, the judgement apparatus specifies the reference visual direction corresponding to the reference trigger information as the preferred visual direction and judges the degree of concentration based on the preferred visual direction and the visual direction.

15. The lecture support system according to claim 11, wherein
if the monitor apparatus does not extract new trigger information within a predetermined time after extracting the trigger information, the image analysis apparatus re-captures the first shot image of a student during the lecture, and re-estimates a visual direction of the student based on the first shot image; and
the judgement apparatus re-judges the degree of concentration of the student based on the trigger information extracted by the monitor apparatus and the re-estimated visual direction.

16. The lecture support system according to claim 11, further comprising:
a display apparatus that displays the degree of concentration that the judgement apparatus transmits.

17. The lecture support system according to claim 16, wherein
in case where the monitor apparatus does not extract new trigger information within the predetermined time after extracting the trigger information, the judgement apparatus transmits attention-attracting information to the display apparatus, if the degree of concentration is at a specified threshold or less.

18. A method of supporting lecture, comprising:
obtaining trigger information that represents specified speech and behavior of a teacher among his speeches and behaviors during a lecture;
obtaining information that represents a visual direction of a student; and
judging degree of concentration of the student based on a preferred visual direction according to the trigger information and the visual direction.

19. A non-transient computer readable medium storing a program that causes a computer to perform processing, comprising:
obtaining trigger information that represents specified speech and behavior of a teacher among his speeches and behaviors during a lecture;
obtaining information that represents a visual direction of a student; and
judging degree of concentration of the student based on a preferred visual direction according to the trigger information and the visual direction.

20. The method of supporting lecture according to claim 18, wherein
the trigger information includes a predetermined word included in voice spoken by the teacher.

21. The method of supporting lecture according to claim 18, wherein
the trigger information includes information regarding status of the teacher.

22. The method of supporting lecture according to claim 18, further comprising:
re-capturing the first shot image of a student during the lecture if new trigger information is not extracted within a predetermined time after extracting the trigger information;
re-estimating a visual direction of the student based on the first shot image; and
re-judging the degree of concentration of the student based on the trigger information and the re-estimated visual direction.

23. The method of supporting lecture according to claim 18, further comprising:
displaying the degree of concentration on a display apparatus.

24. The method of supporting lecture according to claim 23, further comprising:
transmitting attention-attracting information to the display apparatus, if the degree of concentration is at a specified threshold or less and new trigger information is not extracted within the predetermined time after extracting the trigger information.

25. The non-transient computer readable medium storing a program that causes a computer to perform processing according to claim 19, wherein
the trigger information includes a predetermined word included in voice spoken by the teacher.

26. The non-transient computer readable medium storing a program that causes a computer to perform processing according to claim 19, wherein
the trigger information includes information regarding status of the teacher.

27. The non-transient computer readable medium storing a program that causes a computer to perform processing according to claim 19, further comprising:
re-capturing the first shot image of a student during the lecture if new trigger information is not extracted within a predetermined time after extracting the trigger information;
re-estimating a visual direction of the student based on the first shot image; and
re-judging the degree of concentration of the student based on the trigger information and the re-estimated visual direction.

28. The non-transient computer readable medium storing a program that causes a computer to perform processing according to claim 19, further comprising:
displaying the degree of concentration on a display apparatus.

29. The non-transient computer readable medium storing a program that causes a computer to perform processing according to claim 28, further comprising:
transmitting attention-attracting information to the display apparatus, if the degree of concentration is at a specified threshold or less and a new trigger information is not extracted within the predetermined time after extracting the trigger information.
